(19) United States
(12) Patent Application Publication
(10) Pub. No.: US 2020/0306848 A1
(43) Pub. Date: Oct. 1, 2020

(54) RECIPROCATING SAW

(71) Applicant: TECHTRONIC CORDLESS GP, Anderson, SC (US)

(72) Inventors: Michael Preus, Piedmont, SC (US); Brianna Williams, Anderson, SC (US)

(21) Appl. No.: 16/819,414

(22) Filed: Mar. 16, 2020

Related U.S. Application Data
(60) Provisional application No. 62/826,500, filed on Mar. 29, 2019.

(51) Int. Cl. B23D 59/00; B23D 51/00

(52) U.S. Cl. CPC B23D 59/006; B27G 3/00; B23D 51/00

(57) ABSTRACT

A reciprocating saw may include a housing, a motor within the housing, a reciprocating drive mechanism having a rotational input driven by the motor and a reciprocating spindle to which a saw blade is attachable, and an onboard, integrated dust collection system for collecting and storing dust and debris generated by the saw blade during a cutting operation. The dust collection system includes an inlet duct, a dust container positioned downstream of the inlet duct, an outlet duct positioned downstream of the dust container, and a centrifugal fan driven by the motor for inducing an airflow through the inlet duct, the dust container, and the outlet duct.

### CROSS-REFERENCE TO RELATED APPLICATIONS

This application claims priority to co-pending U.S. Provisional Patent Application No. 62/826,500 filed on Mar. 29, 2019, the entire content of which is incorporated herein by reference.

### FIELD

The present disclosure relates to power tools, and more particularly to reciprocating saws.

### BACKGROUND

Reciprocating saws may include transmissions that convert a rotary motion of a motor to a reciprocating motion of a blade. The blade of a reciprocating saw may be used to cut workpieces such as wood, brick, tile, and/or the like. Dust, debris, and the like may be produced during operation of the reciprocating saw that may impede the speed and/or efficiency of the sawing operation. Additionally, dust and debris may impede operator visibility of the blade or workpiece during sawing operations.

### SUMMARY

In one embodiment, a reciprocating saw may include a housing, a motor within the housing, a reciprocating drive mechanism having a rotational input driven by the motor and a reciprocating spindle to which a saw blade is attachable, and an onboard, integrated dust collection system for collecting and storing dust and debris generated by the saw blade during a cutting operation. The dust collection system includes an inlet duct, a dust container positioned downstream of the inlet duct, an outlet duct positioned downstream of the dust container, and a centrifugal fan driven by the motor for inducing an airflow through the inlet duct, the dust container, and the outlet duct.

In another embodiment, a reciprocating saw may include a housing, a motor within the housing, a reciprocating drive mechanism including a rotational input driven by the motor and a reciprocating spindle to which a saw blade is attachable, and an onboard, integrated dust collection system for collecting and storing dust and debris generated by the saw blade during a cutting operation. The dust collection system includes an inlet duct, a dust container positioned downstream of the inlet duct, an outlet duct defined within the housing, a fan driven by the motor to induce a first airflow through the outlet duct, and a vacuum port that is alternately attachable to a remote vacuum source to induce a second airflow that is different from the first airflow.

In another embodiment, a reciprocating saw may include a housing, a motor within the housing, a reciprocating drive mechanism including a rotational input driven by the motor and a reciprocating spindle to which a saw blade is attachable, a shoe extending from the housing against which a workpiece is engageable during a cutting operation, and a removable dust collection system. The dust collection system includes a shroud coupled to the shoe. The shroud includes a blade opening through which the saw blade extends. The dust collection system also includes an inlet duct integral with the shroud and in fluid communication with the shroud. The inlet duct includes a vacuum port that is attachable to a vacuum source to induce an airflow through the shroud and the inlet duct.

### BRIEF DESCRIPTION OF THE DRAWINGS

FIG. 1 is a side view of a reciprocating saw according to an embodiment of the present disclosure.

FIG. 2 is a cross-sectional view of the reciprocating saw of FIG. 1.

FIG. 3 is a side view of a reciprocating saw according to another embodiment of the present disclosure.

FIG. 4 is a cross-sectional view of the reciprocating saw of FIG. 3.

FIG. 5 is a perspective view of a reciprocating saw according to yet another embodiment of the present disclosure.

Before any embodiments of the present disclosure are explained in detail, it is to be understood that the subject matter is not limited in its application to the details of construction and the arrangement of components set forth in the following description or illustrated in the following drawings. The subject matter is capable of other embodiments and of being practiced or of being carried out in various ways. Also, it is to be understood that the phraseology and terminology used herein is for the purpose of description and should not be regarded as limiting.

### DETAILED DESCRIPTION

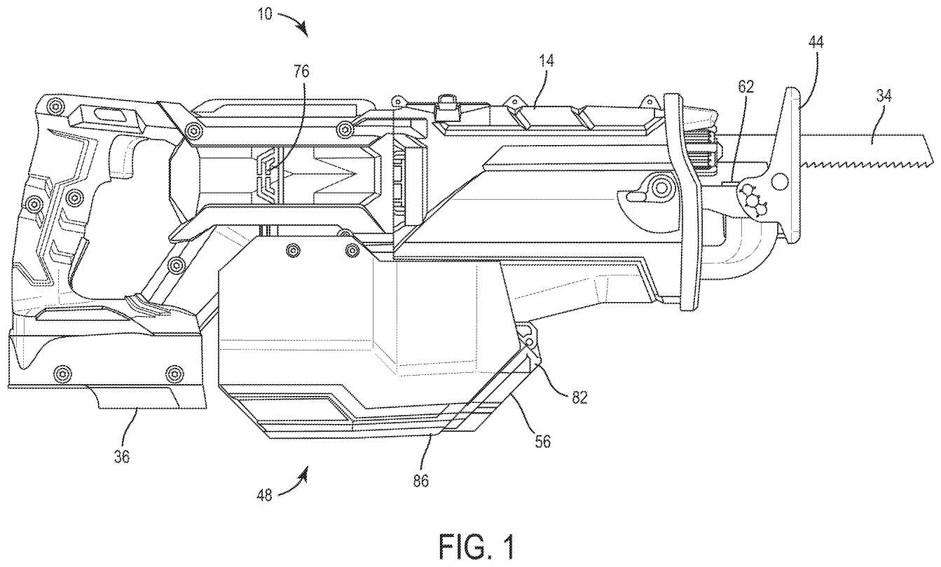

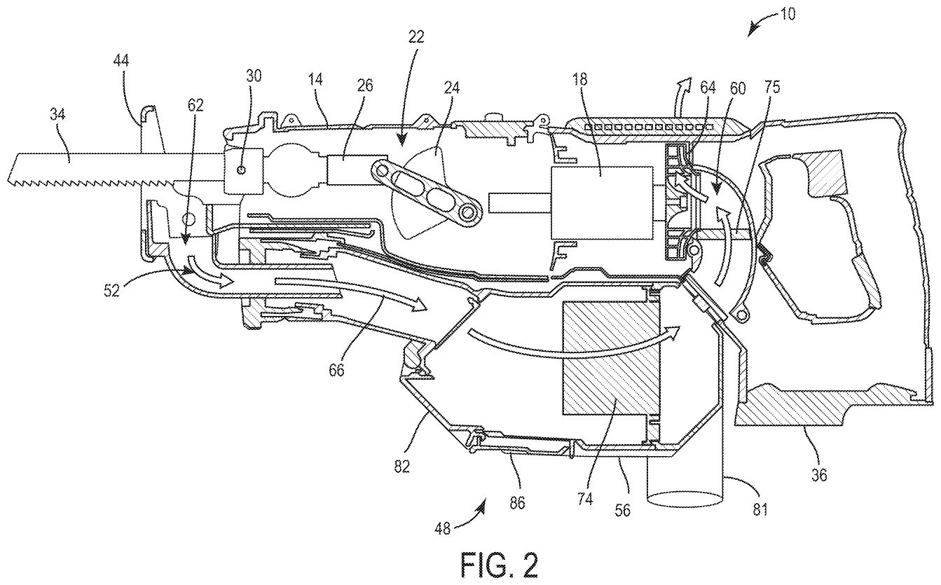

FIGS. 1 and 2 illustrate a reciprocating saw 10 including a housing 14, an electric motor 18 (FIG. 2) within the housing 14, a reciprocating drive mechanism 22 including a rotational input 24 driven by the motor 18 and a reciprocating spindle 26 having a blade clamp mechanism 30 to which a saw blade 34 is attachable. In the illustrated embodiment, the saw 10 includes a battery receptacle 36 to which a rechargeable battery pack (not shown) is attachable for providing power to the motor 18. Alternatively, the saw 10 may include a power cord for connection to an alternating current (AC) power source.

As illustrated in FIG. 2, the reciprocating saw 10 also includes a shoe 44 or guide member operable to engage a workpiece and provide stability to the saw 10 during a cutting operation. The shoe 44 extends from the housing 14 and is located forward of the blade clamp mechanism 30 to function as a stop to limit the depth to which the blade 34 may penetrate into the workpiece. In some embodiments, the shoe 44 may freely pivot to allow the user to adjust an angle at which the blade 34 penetrates the workpiece during a cutting operation.

With reference to FIGS. 1 and 2, the saw 10 further includes an onboard, integrated dust collection system 48 for collecting and storing dust and other debris generated during a cutting operation. In other words, the dust collection system 48 is fully supported by the reciprocating saw 10. The dust collection system 48 includes an inlet duct 52 (FIG. 2) removably coupled to the housing 14, a dust container 56 positioned downstream of the inlet duct 52, an outlet duct 60 defined within the housing 14, and a centrifugal fan 64 driven by the motor 18 when activated to induce an airflow 66 through the inlet duct 52, the dust container 56, and the outlet duct 60. Referring to FIG. 2, the inlet duct 52 is positioned behind the shoe 44 relative to the motor 18. The inlet duct defines an opening 62 into the dust collection system 48. The opening 62 opens in a direction that is generally perpendicular to the reciprocating direction of the saw blade 34. In other words, the opening 62 is in facing relationship with the saw blade 62. The inlet duct is removably coupled to the shoe 44 and moveable with the shoe 44 relative to the housing 14. In other embodiments, the opening 62 may open in a direction that is oblique to the reciprocating direction of the saw blade 34 or that is parallel to the reciprocating direction of the saw blade 34.

With continued reference to FIG. 2, the dust collection system 48 includes a filter 74 (e.g., a first air filter) located in the dust container 56 to filter particulate debris of greater than a first size (e.g., greater than 2 microns, greater than 1 micron, etc.) from the airflow 66. As such, debris is prevented from moving with the airflow 66 downstream of the filter 74, causing the debris to accumulate in a portion of the dust container 56 upstream of the filter 74. The dust container 56 includes a lid 82 (see also FIG. 1) that is pivotably coupled to the rest of the dust container 56. The lid 82 may be selectively opened to empty the accumulated dust and other debris from the container 56. In alternate embodiments, the entire dust container 56 may be removable from the inlet and outlet ducts 52, 60 to empty the accumulated dust and debris. A quick-release mechanism 86 may be used to open and close the lid 82 to allow quick emptying of accumulated dust and debris.

The filtered airflow 66 downstream of the filter 74 is configured to pass through the outlet duct 60 before reaching an inlet region of the centrifugal fan 64. The airflow 66 entering the inlet region of the centrifugal fan 64 is redirected and discharged radially outward through an outlet opening 76 in the housing 14 adjacent the fan 64 (FIG. 1). The outlet opening 76 may comprise a plurality of openings through which air may be expelled from the reciprocating saw 10. Portions of the opening 76 may be shaped so that the expelled air is caused to blow away from the user to not interfere with the user during a cutting operation.

In some embodiments, the reciprocating saw 10 may include a second filter 75 positioned in the outlet duct 60 (FIG. 2). The second filter 75 may act as a secondary filter by which finer dust and/or particulate debris, having a second size smaller than the first size filtered by the primary filter (i.e., filter 74), may be removed from the airflow 66. For example, the second filter may remove particulate debris of the second size that is greater than 0.5 microns, greater than 0.10 microns, etc. Additionally, the second filter 75 may act as a primary air filter by which dust and/or particulate debris may be removed from the airflow 66 in instances where the filter 74 within the dust container 56 is not used or otherwise removed.

In some embodiments, the dust container 56 may include an integrated vacuum port 81 to which a vacuum hose (attached to a remote vacuum source, not shown) is attachable for inducing the airflow 66 through the inlet port 52, the dust container 56, and the filter 74 instead of relying upon the fan 64 to induce the airflow 66. In use, connecting the vacuum hose to the vacuum port 81 may also close the passage between the dust container 56 and the outlet duct 60 to prevent an undesired secondary airflow from being induced in a reverse direction through the opening 76 and the outlet duct 60.

During operation of the reciprocating saw 10, the motor 18 is configured to simultaneously drive the reciprocating drive mechanism 22, for imparting reciprocation to the saw blade 34, and the centrifugal fan 64, inducing the airflow 66. The induced airflow 66 enters the inlet duct 52 via the opening 62, carrying dust and debris, generated by the saw blade 34 during a cutting operation, into the inlet duct 52. The dust and debris-laden airflow 66 then enters the dust container 56. The dust and debris then impact the filter 74, which causes the dust and debris to fall out of the airflow 66 as the air continues to flow through the filter 74 and into the outlet duct 60. Filtered airflow 66 may be routed downstream of the filter 74 and pass through the second filter 75, which removes finer dust and debris from the airflow 66, and through the outlet duct 60 before reaching the inlet region of the centrifugal fan 64. The airflow 66 enters the inlet region of the centrifugal fan 64, is redirected, and is then discharged radially outward through the outlet opening 76 in the housing 14. Alternatively, a vacuum hose may attach to the vacuum port 81 (FIG. 2) on the dust container 56, in some embodiments. The outlet duct 60 is closed in response to attachment of a vacuum hose to the vacuum port 81. For example, a portion of the vacuum hose may close or block off the outlet duct 60 upon insertion of the vacuum hose in the vacuum port 81. In this way, dust and debris may be automatically collected during a cutting operation, which improves the speed and/or efficiency of cutting operations. Further, automatically clearing dust and debris from a workpiece improves operator visibility of the saw blade 34 and a cut line on the workpiece.

In some embodiments, the airflow 66 may also be used to cool the battery pack or alternate power source, the motor 18, and/or the saw blade 34. In other embodiments, one or more additional fans may be disposed in, on, or over the reciprocating saw 10 for cooling the battery pack or alternate power source, the motor 18, and/or the saw blade 34.

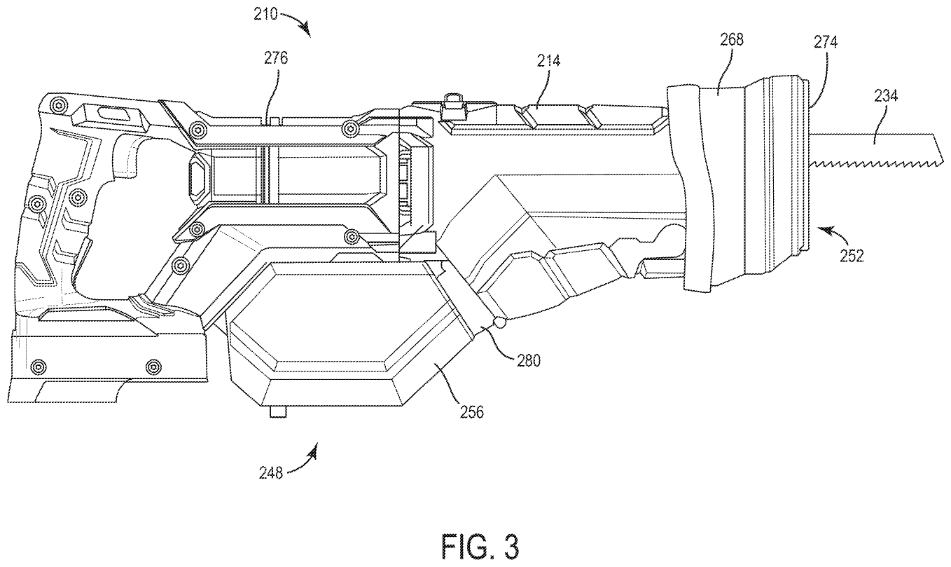

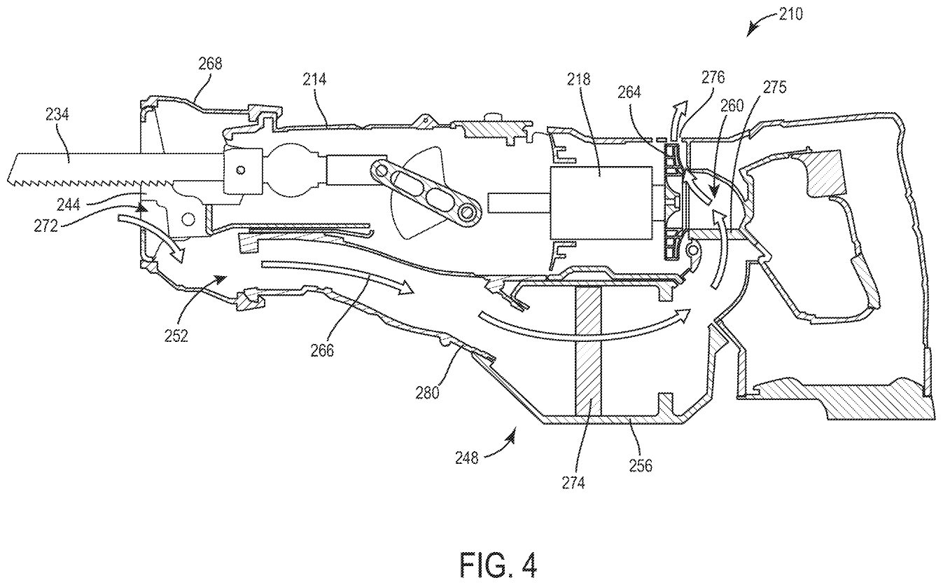

FIGS. 3 and 4 illustrate a reciprocating saw 210 according to another embodiment. The reciprocating saw 210 is similar to the reciprocating saw 10 with like features being represented with like reference numerals plus “200.” As such, only features that differ will be discussed below.

With reference to FIG. 4, the inlet duct 252 includes a shroud 268 surrounding the shoe 244 and having an opening 272 through which the shoe 244 and/or the saw blade 234 is extendable. When the shoe 244 contacts a workpiece during a cutting operation, the opening 272 of the shroud 268 is spaced from, but in close proximity to, the workpiece to provide a gap through which the airflow 266 entering the inlet duct 252 may be induced. The shroud 268 also directs dust and debris from a workpiece during a cutting operation into the dust collection system 248. The shroud 268 may also be collapsible and expandable in response to adjustment of the shoe 244 for allowing more or less of the saw blade 234 to plunge into the workpiece during a cutting operation. In some embodiments of the saw 210, the shroud 268 may be removed from the remainder of the inlet duct 252 if the user desires not to use the dust collection system 248 in a cutting operation.

In the illustrated embodiment, the dust container 256 is removable from the inlet and outlet ducts 252, 260 to empty the accumulated dust and other debris. Once the dust and debris are emptied, the dust container 256 is reattached to the inlet and outlet ducts 52, 60. Although not shown, one or more quick-release mechanisms may be used to connect the dust container 256 to the inlet duct 252 and the outlet duct 260, respectively.

With continued reference to FIG. 4, the dust collection system 248 may additionally include a vacuum port 280 which, if the dust container 256 is removed, is attachable to a vacuum hose through which an airflow is induced in a similar manner as the fan 264 when the dust container 256 is attached. The vacuum port 280 is positioned between the inlet duct 252 and the dust container 256. In other words, the vacuum port 280 is downstream of the inlet duct 252. In the illustrated embodiment, the vacuum port 280 is integral with the inlet duct 252. In other embodiments, the vacuum port 280 may be a separate component that is removable from the inlet duct 252 if not needed.

When the vacuum hose is attached to the vacuum port 280 in lieu of the dust container 256, the vacuum source induces an airflow through the inlet duct 252 that continually carries away dust and other debris from the workpiece through the vacuum port 280 and into the vacuum source without needing to repeatedly stop the cutting operation and empty the dust container 256. However, when the dust container 256 is used, the dust container 256 is attachable to the inlet duct 252 via the vacuum port 280, the outlet of which is exposed to the portion of the dust container 256 upstream of the filter 74. When the dust container 256 is attached to the vacuum port 280, the fan 264 induces an airflow through the inlet duct 252, the dust container 256, and the outlet duct 260.

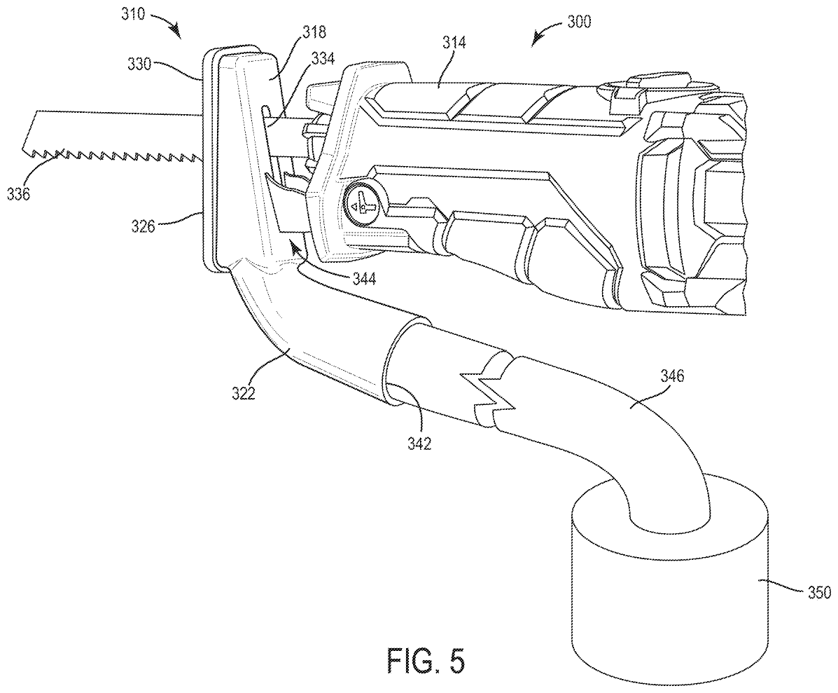

FIG. 5 illustrates a reciprocating saw 300 according to another embodiment of the disclosure. The reciprocating saw 300 is similar to the reciprocating saws 10, 210 described above, but instead includes a dust collection system 310 having a shroud 318 and an inlet duct 322 integral with and in fluid communication with the shroud 318. The inlet duct 322, in turn, is connected to a remote vacuum source 350 via a vacuum hose 346.

The shroud 318 is positioned in front of the housing 314 and is attached to the housing 314 by a shoe 344 similar to the shoe 44 in FIG. 1 or the shoe 244 in FIG. 4. The shroud 318 defines a chamber (not shown) with an opening 326 facing away from the reciprocating saw 300 and a sealing member 330 (e.g., a rubber gasket, and/or the like) surrounding the opening 326. The opening 326 may be positioned adjacent a workpiece to seal against the workpiece where a saw blade may be performing a cutting operation. The shroud 318 further includes a blade opening 334 at the rear thereof through which a saw blade 336 extends. In the illustrated embodiment, the shroud 318 only surrounds a portion of the saw blade 336 between the front end of the saw blade 336 and the rear end of the saw blade 336, allowing unobstructed visibility of the saw blade 336 to a user behind the shoe 344 during a cutting operation. The shroud 318 has a generally rectangular cross-sectional shape (i.e., through a plane extending perpendicular to the saw blade 336), although in other embodiments the shroud 318 may have other shapes. The inlet duct 322 extends below the saw 300 and includes a vacuum port 342, which is attachable to the vacuum hose 346 of the vacuum source 350, which induces an airflow through the shroud 318, the inlet duct 322, and the vacuum hose 346.

During a cutting operation, a user may attach the dust collection system 310 to the reciprocating saw 300 and the vacuum source 350 to the vacuum port 342. A user may then press the shroud 318 of the dust collection system 310 against a workpiece to perform a cutting operation. When pressed against the workpiece, the sealing member 330 engages the workpiece creating a seal that prevents dust and other debris created during a cutting operation from exiting into the surrounding area as the reciprocating saw 300 performs a cutting operation. The dust and debris is temporarily trapped within the shroud 318, and the vacuum source 350 draws it through the inlet duct 322 and vacuum hose 346, and into a storage bin for later removal.

Various features of the disclosure are set forth in the following claims.

What is claimed is:

1. A reciprocating saw comprising:
a housing;
a motor within the housing;
a reciprocating drive mechanism including a rotational input driven by the motor and a reciprocating spindle to which a saw blade is attachable; and
an onboard, integrated dust collection system for collecting and storing dust and debris generated by the saw blade during a cutting operation, the dust collection system including:
an inlet duct,
a dust container positioned downstream of the inlet duct,
an outlet duct positioned downstream of the dust container, and
a centrifugal fan driven by the motor for inducing an airflow through the inlet duct, the dust container, and the outlet duct.

2. The reciprocating saw of claim 1, further comprising a battery receptacle to which a rechargeable battery pack is attachable to power the motor.

3. The reciprocating saw of claim 1, further comprising a shoe extending from the housing against which a workpiece is engageable during the cutting operation.

4. The reciprocating saw of claim 3, wherein the inlet duct is positioned rearward of the shoe.

5. The reciprocating saw of claim 4, wherein the inlet duct defines an opening that is in facing relationship with the saw blade.

6. The reciprocating saw of claim 3, wherein the inlet duct is removably coupled to the shoe and movable with the shoe relative to the housing.

7. The reciprocating saw of claim 1, wherein the dust collection system further includes a filter positioned in the dust container upstream of the outlet duct.

8. The reciprocating saw of claim 7, wherein the filter is a first filter, and wherein the dust collection system further includes a second filter positioned in the outlet duct.

9. The reciprocating saw of claim 1, wherein the dust container includes a lid that is selectively openable to empty collected and stored dust and debris from the dust container.

10. The reciprocating saw of claim 9, wherein the dust container further includes a quick release mechanism to open and close the lid.

11. The reciprocating saw of claim 1, wherein the airflow is discharged radially outward by the fan through an opening in the housing adjacent the fan.

12. The reciprocating saw of claim 11, wherein the outlet opening includes a plurality of openings through which air may be expelled from the reciprocating saw.

13. The reciprocating saw of claim 1, wherein the dust collection system includes a vacuum port that is attachable to a vacuum source remote from the reciprocating saw, and wherein the outlet duct is fluidly disconnected from the inlet duct when the vacuum port is attached to the vacuum source.

14. The reciprocating saw of claim 13, wherein the vacuum port is positioned on the dust container and is in fluid communication with an interior of the dust container.

15. The reciprocating saw of claim 14, wherein the outlet duct is closed in response to attachment of a vacuum hose to the vacuum port.

16. The reciprocating saw of claim 13, wherein the vacuum port is integrally formed with the inlet duct, and wherein the dust container is removable from the reciprocating saw to access the vacuum port for attachment to a vacuum hose of a remote vacuum source.

17. The reciprocating saw of claim 1, wherein the motor simultaneously drives the reciprocating drive mechanism and the centrifugal fan.

18. A reciprocating saw comprising:
a housing;
a motor within the housing;
a reciprocating drive mechanism including a rotational input driven by the motor and a reciprocating spindle to which a saw blade is attachable; and
an onboard, integrated dust collection system for collecting and storing dust and debris generated by the saw blade during a cutting operation, the dust collection system including:
an inlet duct,
a dust container positioned downstream of the inlet duct,
an outlet duct defined within the housing,
a fan driven by the motor to induce a first airflow through the outlet duct, and
a vacuum port that is alternately attachable to a remote vacuum source to induce a second airflow that is different from the first airflow.

19. The reciprocating saw of claim 18, wherein the first airflow extends through the inlet duct, the dust container, and the outlet duct, and wherein the second airflow extends through the inlet duct, the vacuum port, and into the vacuum source.

20. The reciprocating saw of claim 18, wherein the vacuum port is positioned between the inlet duct and the dust container.

21. The reciprocating saw of claim 20, wherein the dust container is removable from the reciprocating saw to access the vacuum port for attachment to a vacuum hose of the remote vacuum source.

22. The reciprocating saw of claim 18, further comprising a shoe extending from the housing, and wherein the dust collection system further includes a shroud surrounding the shoe to direct dust and debris into the inlet conduit.

23. The reciprocating saw of claim 18, wherein the first airflow extends through the inlet duct, the dust container, and the outlet duct, and wherein the second airflow extends through the inlet duct, the dust container, the vacuum port, and into the vacuum source.

24. The reciprocating saw of claim 23, wherein the outlet duct is closed in response to attachment of a vacuum hose of the remote vacuum source to the vacuum port.

25. A reciprocating saw comprising:
a housing;
a motor within the housing;
a reciprocating drive mechanism including a rotational input driven by the motor and a reciprocating spindle to which a saw blade is attachable;
a shoe extending from the housing against which a workpiece is engageable during a cutting operation; and
a removable dust collection system including:
a shroud coupled to the shoe, the shroud including a blade opening through which the saw blade extends, and
an inlet duct integral with the shroud and in fluid communication with the shroud, the inlet duct including a vacuum port that is attachable to a remote vacuum source to induce an airflow through the inlet duct and the shroud.
